(19) United States
(12) Patent Application Publication
(10) Pub. No.: US 2023/0385917 A1
(43) Pub. Date: Nov. 30, 2023

(54) SYSTEM, METHOD, AND COMPUTER PROGRAM PRODUCT FOR AUGMENTED REALITY VISUALIZATION OF VIRTUAL OBJECTS

(71) Applicant: 12179288 CANADA INC., Toronto (CA)

(72) Inventors: Viktor BELILOVSKIY, Toronto (CA); Dina GITIS, Hollywood, FL (US)

(73) Assignee: 12179288 CANADA INC., Toronto (CA)

(21) Appl. No.: 17/825,639

(22) Filed: May 26, 2022

(51) Int. Cl. G06Q 30/06; G06V 20/20; G06V 20/64; G06V 40/10; G06V 10/25; G06T 19/20; G06T 19/00

(52) U.S. Cl. CPC G06Q 30/0643; G06Q 30/0623; G06V 20/20; G06V 20/64; G06V 40/10; G06V 10/25; G06T 19/20; G06T 19/006; G06T 2219/2004

(57) ABSTRACT

A method for augmented reality visualization of virtual objects. The method includes receiving a selected object of interest, receiving and displaying a body part of a user in a video stream, detecting a region of the video stream in which the body part of the user is located, determining boundaries of the body part, recognizing anchor points on the body part, segmenting the body part so as to determine boundaries of constituent parts of the body part, superimposing, in real time in the video stream, a three-dimensional model of the object of interest in a desired location on the body part, and continuously repositioning and reorienting, in real time in the video stream, the three-dimensional model of the object of interest in the desired location on the body part, based on a repositioning and reorienting of the body part.

### BACKGROUND

Online purchasing of fine and custom jewelry is a large and growing market, with over US$20 billion spend on such purchases annually in recent years. However, the return rate for online jewelry purchases is about 30%, amounting to over US$6 billion. The most common reasons given for returns of jewelry purchased online is that the jewelry “does not match”, or that the customer does not like the jewelry, with approximately 65% of jewelry being returned for these reasons. Additionally, the cost of processing returns is 8%.

Typical online jewelry purchasing systems may show a photograph of a jewelry piece, or several photographs of the piece from different points of view. However, such a presentation does not allow a customer to visualize how the jewelry piece would look when worn by the customer. A jewelry piece that looks attractive in an online shopping image may look different to a customer when worn by the customer. Allowing the customer to visualize the jewelry piece as worn may reduce the likelihood of post-purchase dissatisfaction and returns.

Accordingly, a solution to improve the visualization of jewelry pieces during online purchases is desired.

### SUMMARY

According to at least one exemplary embodiment, a method for augmented reality visualization of virtual objects is disclosed. The method can include receiving a selected object of interest, receiving and displaying a body part of a user in a video stream, detecting a region of the video stream in which the body part of the user is located, determining boundaries of the body part, recognizing anchor points on the body part, segmenting the body part so as to determine boundaries of constituent parts of the body part, superimposing, in real time in the video stream, a three-dimensional model of the object of interest in a desired location on the body part, and continuously repositioning and reorienting, in real time in the video stream, the three-dimensional model of the object of interest in the desired location on the body part, based on a repositioning and reorienting of the body part.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1A shows an exemplary embodiment of a system for augmented reality visualization of three-dimensional objects.

FIG. 1B shows an exemplary computing device.

FIG. 1C shows an exemplary embodiment of a system for augmented reality visualization of three-dimensional objects.

FIG. 1D shows an exemplary embodiment of a system for augmented reality visualization of three-dimensional objects.

FIG. 2A shows an exemplary selection interface of a system for augmented reality visualization of three-dimensional objects.

FIG. 2B shows another exemplary selection interface of a system for augmented reality visualization of three-dimensional objects.

FIG. 2C shows another exemplary selection interface of a system for augmented reality visualization of three-dimensional objects.

FIG. 3A shows an exemplary camera view interface of a system for augmented reality visualization of three-dimensional objects.

FIG. 3B shows another exemplary camera view interface of a system for augmented reality visualization of three-dimensional objects.

FIG. 3C shows another exemplary camera view interface of a system for augmented reality visualization of three-dimensional objects.

FIG. 4A shows exemplary anchor point locations on a right hand.

FIG. 4B shows exemplary anchor point locations on a left hand.

FIG. 5 shows an exemplary method for augmented reality visualization of three-dimensional objects.

FIG. 6 shows an exemplary method for sizing and calibration of the system for augmented reality visualization of three-dimensional objects.

### DETAILED DESCRIPTION

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

According to at least one exemplary embodiment, a system, method, and computer program product for augmented reality visualization of virtual objects is disclosed. The system, method, and software program product can facilitate real-time augmented reality display of virtual objects on an actual object, with the virtual object being positioned on the actual object such that the virtual object follows the movements and orientation of the actual object. For example, a virtual object may be a ring, and an actual object may be a hand of a user.

According to at least one exemplary embodiment, the system may be adapted to independently determine parts of a user's body by using the main and front cameras of a user's communications or computing device and to superimpose three-dimensional virtual objects on the live video stream obtained from the camera, synchronizing the video stream with three-dimensional products in real time. The synchronization speed may be, for example 30-60 frames per second.

According to at least one exemplary embodiment, a user may choose a product, such as a jewelry piece, for different parts of the body. The different parts of the user's body may include, but are not limited to, hands, wrists, arms, ears, neck, face, legs, ankles, feet, and so forth. The products may include, but are not limited to, rings, bracelets, watches, earrings, piercings, necklaces, arm bands, anklets, and so forth. The user may then have the ability to review textual, photo and video information of the product, as well as delivery time and final cost. The user may further have the ability to take photos or videos of at least a part of the user's body having a virtual object of the selected product displayed thereon.

According to at least one exemplary embodiment, the system may synchronize an application disposed on a communications or computing device of the user with a server, thereby updating databases of the products and associated prices, descriptions and auxiliary information. Such updates may occur in the background when the user is using the application. The system can facilitate easy addition or removal of products, as well as changes of product descriptions, prices, three-dimensional models and any other relevant content on the application, and can also facilitate synchronizing product databases with other systems, for example point-of-sale and accounting systems. The system may include a virtual object library containing three-dimensional, photorealistic models of products, such as jewelry products, watches, and so forth. The three-dimensional models may be provided so as to achieve a natural appearance, including appearances of materials, reflections, refraction, subsurface reflections, and so forth. The system can allow a user to evaluate not only the appearance of a product, but also the compatibility of the product with both the anatomical features of the user as well as other, non-virtual products worn by the user (for example, other jewelry pieces), as well as to choose the right size, material, and configuration of the product.

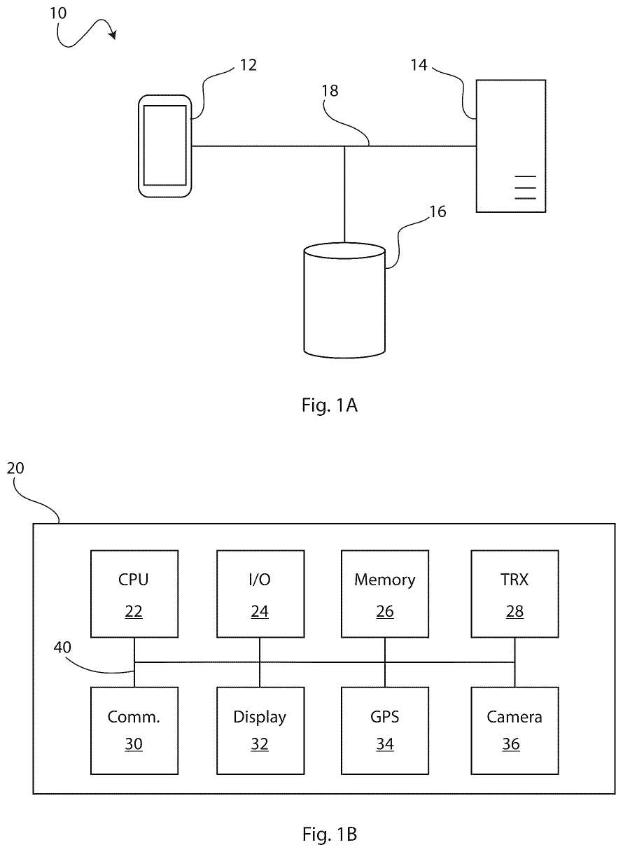

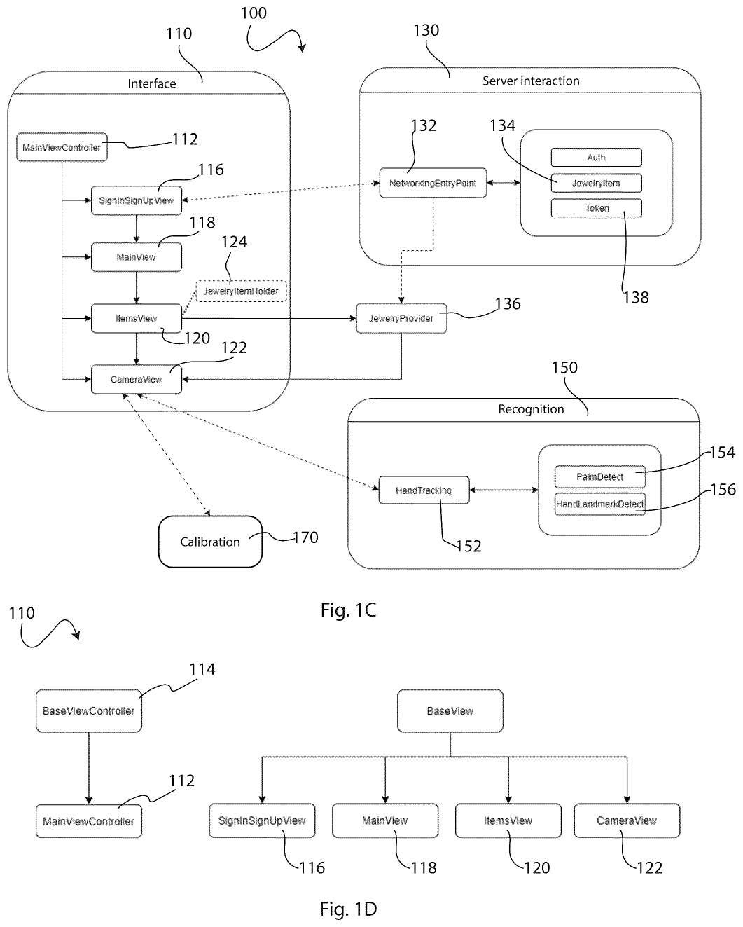

As shown in FIG. 1A, an exemplary embodiment of a system 10 for augmented reality visualization of three-dimensional objects may include a mobile computing device 12, a server 14, a database 16 and a network 18. However, it should be appreciated that such a configuration is merely exemplary and that system 10 may be provided in any manner that enables the system to function as described herein. In one embodiment, system 10 can be implemented on one or more servers 14 and one or more databases 16, and can operate to deliver content and functionality to interfaces on the mobile computing device 12. The interfaces can be implemented to display or otherwise communicate via browser, application or other user interfaces. The interfaces can be used by customers and/or service providers to facilitate and improve the ability to provide products to customers. The elements of the system 10 can communicate with each other and with customers and service providers via a communication network such as communication network 18.

Server 14 can be any suitable computing device that includes any hardware or hardware and software combination for processing and handling information. Server 14 may be a computer, a workstation, a laptop, a server such as a cloud-based server, or any other suitable device. The mobile computing device 12 can be a cellular phone, a smart phone, a tablet, a personal assistant device, a voice assistant device, a digital assistant, a laptop, a computer, or any other suitable device. In an exemplary embodiment, server 14 may be operated by a vendor or shop owner, for example of jewelry pieces, while mobile computing device 12 can be operated by customers or clients. System 10 can operate to communicate information and provide functionality, as will be further described, between the vendors and customers.

The communication network 18 can provide access to the internet and may be any suitable communication system to receive, transmit and/or exchange information between local or remote elements of the system, such as for example, WiFi, cellular, Bluetooth® network, satellite network, wireless local area network, a wide area network, or any other suitable network.

Database 16 can be a remote storage device, such as a cloud-based server, a memory device on another application server, a networked computer, or any other suitable remote storage. In some exemplary embodiments, database 16 may be a local storage device, such as a hard drive, non-volatile memory or storage, and so forth.

FIG. 1B shows an exemplary computing device 20 as generally known, that can be used with exemplary embodiments of system 10, for example the mobile computing device 12 and/or server 14. Computing device 20 may include one or more processors 22, one or more input/output devices 24, memory 26, a transceiver 28, one or more communication ports 30, a display 32, a geolocator 34, and a camera 36 all operatively coupled to one or more data buses 40. Data buses 40 allow for wired or wireless communication among the various devices. Processors 22 can be configured to perform one or more of any function, method, or operation disclosed herein. Display 32 can display interfaces of the system that can enable customer interaction with the system. Camera 36 can capture a field of view in which a body part of a user is present, so as to provide the functionality described herein.

In some exemplary embodiments, the system can include a mobile application, interfaces of which can be displayed on a mobile computing device. In other exemplary embodiments, the interfaces can be made available as a cloud-based application residing on a remote server. Any implementation that enables the system to function as described herein can be contemplated and provided as desired.

According to at least one exemplary embodiment, and as shown in FIGS. 1C-1D, a system 100 for augmented reality visualization of three-dimensional objects may include a user interface module 110, a server interaction module 130, a recognition module 150, and a calibration module 170. The user interface module 110 may include a main view controller 112 and base view controller 114, which may link several user interface view screens into a single logical chain. For example, main view controller 112 and base view controller 114 may link a sign-in interface 116, a main view interface 118, an item view interface 120, and a camera view interface 122. Item view interface may further be linked to a jewelry item holder container 124.

The various user interface elements may have the following functionality. Sign-in interface 116 may contain the fields and logic for user registration and authorization with system 100. Main view interface 118 may include one or more interfaces directed towards product category selection (for example, bracelets, rings, watches, and so forth). Item view interface 120 may contain a list of products for the selected category, as well as logic for selecting an item so as to perform the virtual fitting operation. Furthermore, the jewelry item holder container 124 may include data regarding a specific product model. Camera view interface 122 may include a live video stream from the camera of the user's computing or communications device and may show the virtual object superimposed on a body part of the user, the virtual object being moved and positioned according to the movements of the body part.

Server interaction module 130 may perform functions of registration and authorization of the user, as well as obtaining a set of information about available products. The server interaction module may include a networking entry point class 132, a product item class 134, a product provider class 136, and various constants 138. The networking entry point class 132 may contain mechanisms for communicating with the server, including registration, authorization, and so forth. The networking entry point class 132 may further interact with containers for storing information. Product item class 134 may contain information about products stored in a server database, while product provider class 136 may provide functionality for interacting with the selected product.

Recognition module 150 may include classes for facilitating recognition of body parts of a user and the sizes of body parts of a user. In one exemplary embodiment, for recognizing the hand and wrist of a user, and the sizes thereof, recognition module 150 may include a hand tracking class 152, a palm detect class 154, and a hand landmark detect class 156. Hand tracking class 152 may implement mechanisms for identifying the hand in the video stream, palm detect class 154 may implement mechanisms for finding the palm of the hand in the video stream, and hand landmark detection class 156 may implement mechanisms for determining anchor points of the hand in the video stream. Furthermore, calibration module 170 may be configured for calibrating the system based on images of standard reference objects received via the camera.

System 100 may be configured to display virtual objects on different parts of the user's body, which may include, but are not limited to, hands, wrists, arms, ears, neck, face, legs, ankles, feet, and so forth. The virtual objects may be of products which may include, but are not limited to, rings, bracelets, watches, earrings, piercings, necklaces, arm bands, anklets, and so forth. Therefore, the following examples, which are described with respect to a user's hand should be considered exemplary and not limiting in any way.

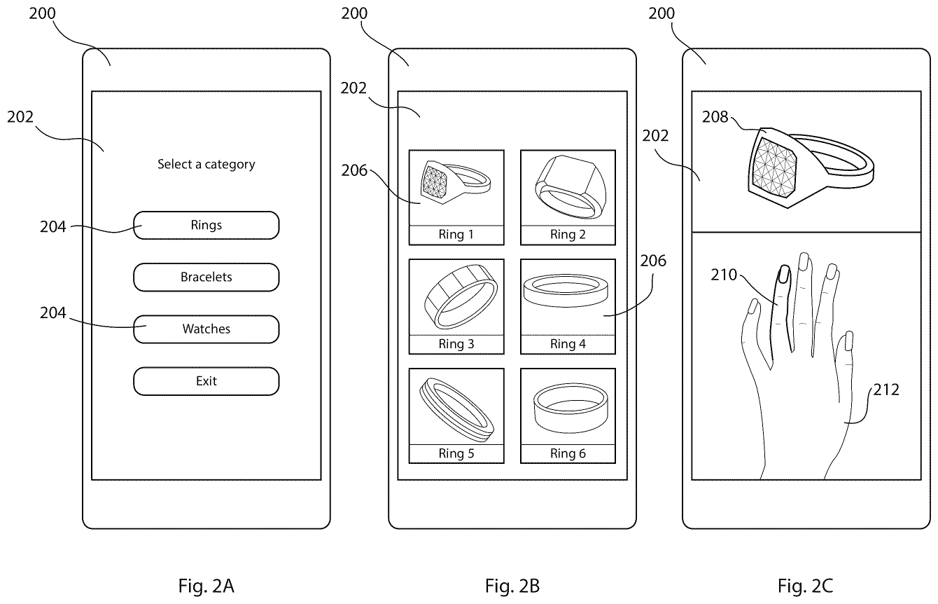

As an example, as shown in FIGS. 2A-2C, a user may wish to display a ring on a finger of the user's hand. The system, via the application on the user's device 200, may display an interface 202 showing various categories 204 of products. The user may then select a “rings” category via the interface. The system may then display an item view interface, presenting the user with various ring models 206 that are available. The user may then select a particular ring 208 that is of interest to the user. Subsequently, the system may prompt the user to select a particular finger 210 on which the ring is to be displayed. Such a prompt may be presented, for example, via an interface showing an image of a hand 212 with the fingers of the hand available for selection. Furthermore, if the selected finger already has a virtual object on it, such as another ring, the system may prompt the user as to whether the user wishes to replace the existing virtual object or view the new virtual object in addition to the existing virtual object.

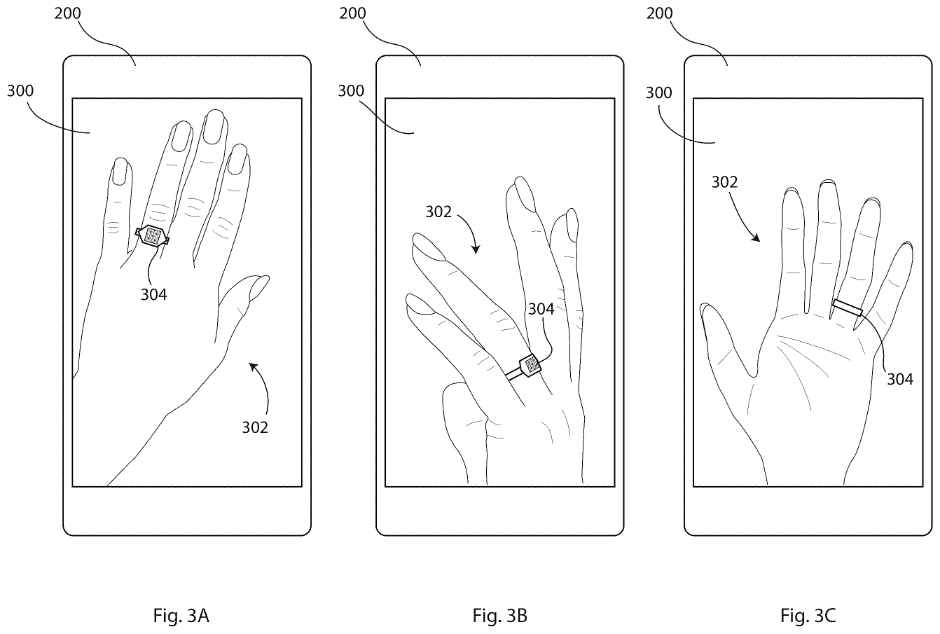

Turning to FIGS. 3A-3C, once the desired finger is selected, the system may display a camera view interface 300, showing an image or live stream from the camera of the user's device. The system may analyze characteristics of the camera frame, for example such as lighting, and may automatically adjust parameters, such as, for example, white balance and aperture, to obtain an optimal image. When the user's hand 302 is within the field of view of the camera, it may be displayed and tracked on the screen of the device. The selected ring may then be superimposed as a virtual object 304 on the desired finger of the user's hand 302. At any point in time, the position and orientation of the virtual object 304 that is displayed on the screen may correspond to the position and orientation of the user's hand as viewed via the camera and displayed on the screen. The position and orientation of the virtual object 304 may be adjusted in real time as the user moves the hand 302 and fingers of the hand.

As another example, a user may wish to display a watch or bracelet on wrist of the user's hand. The system, via the application on the user's device, may display a main view interface showing various categories of products. The user may then select a “bracelets” or “watches” category via the interface. The system may then display an item view interface, presenting the user with various bracelet and/or watch models that are available. The user may then select a particular bracelet or watch that is of interest to the user. Subsequently, the system may prompt the user to select a position on the wrist on which the bracelet or watch is to be displayed. Such a prompt may be presented, for example, via an interface showing an image of a hand and wrist with different areas of the wrist available selection. Furthermore, if the selected finger already has a virtual object on it, such as another watch or bracelet, the system may prompt the user as to whether the user wishes to replace the existing virtual object or view the new virtual object in addition to the existing virtual object.

Once the desired finger is selected, the system may display a camera view interface, showing an image or live stream from the camera of the user's device. The system may analyze characteristics of the camera frame, for example such as lighting, and may automatically adjust parameters, such as, for example, white balance and aperture, to obtain an optimal image. When the user's hand is within the field of view of the camera, it may be displayed and tracked on the screen of the device. The bracelet or watch may then be superimposed at the desired position on the user's wrist. At any point in time, the position and orientation of the bracelet or watch that is displayed on the screen may correspond to the position and orientation of the user's hand as viewed via the camera and displayed on the screen. The position and orientation of the bracelet or watch may be adjusted in real time as the user moves the hand and wrist.

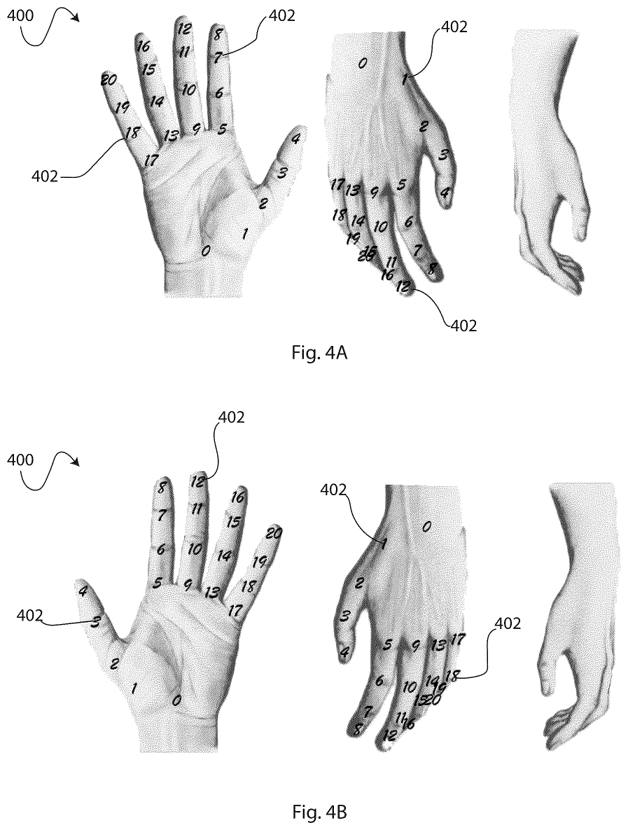

The recognition module 150 of system 100 may track body parts by providing a plurality of anchor points for each body part. For example, for hand tracking, recognition model 150 may provide twenty anchor points 402 on the hand 400, as shown in FIGS. 4A-4B. Three combinations of the position of each hand are may be considered, with two available for recognition. Recognition of the location of the wrist may be calculated geometrically based on the position of other anchor points in space. The anchor points may be provided as three-dimensional coordinates.

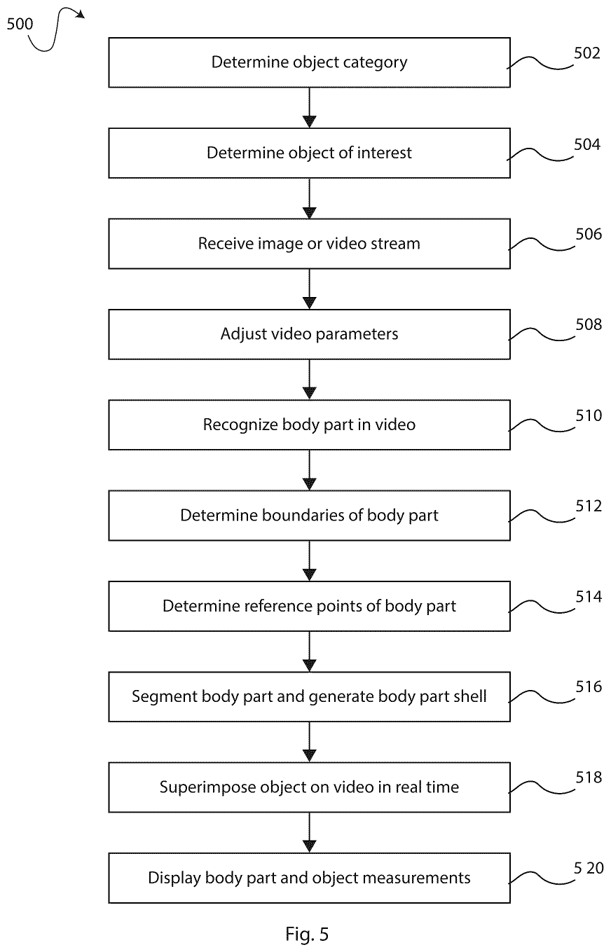

According to another exemplary embodiment, and as shown in FIG. 5, a method 500 for augmented reality visualization of three-dimensional objects is disclosed. At step 502, a user may select a category of products of interest. At step 504, the user may select a particular object of interest within the category. Furthermore, in situations where the product may be placed on a variety of body parts (for example, a ring may be placed on one of several fingers), the user may select the particular body part on which the virtual object of the product will be displayed. At step 506, the system may receive an image or video stream from a camera of the user's computing or communications device. At step 508, the image may be rescaled, and the parameters of the image may be prepared for the parameters required by recognition module 150. At step 510, the region in which the user's body part is located in the image may be detected. For example, the region in which the user's hand may be detected. At step 512, post-processing and determination of boundaries of the body part may be performed. The determination of boundaries may be performed by various techniques, for example by utilizing neural networks, machine learning, region-based convolutional neural networks, and/or “you only look once” techniques. At step 514, anchor points within the boundaries of the body part may be recognized. This may be performed by machine learning techniques, such as, for example, MediaPipe, so as to recognize place a plurality of anchor points on the body part. For example, as shown in FIGS. 3A-3B, a plurality of anchor points may be placed at desired locations on both the palm side and back side of a user's hand.

Subsequently, at step 516, the body part may be segmented so as to determine the boundaries of constituent parts of the body part (for example, if the body part is a hand, it may be segmented so as to determine the boundaries of the fingers). Notably, segmentation and landmarking may be performed solely using RGB data, without utilizing 3D data, nor a 3D sensor of the user device. To perform step 516, a custom jitter removal algorithm may be used. The algorithm may be based on dynamically adjusting thresholds as well as a Kalman filter to reduce jitter. Furthermore, in step 516, landmark positions may be corrected utilizing a color detection model (for example, utilizing OpenCV in Python to detect objects of similar color). Furthermore, to improve alignment of the 3D object with the image of the body part, a morphable 3D model approximation of the body part may be generated and used to correct the rotation and translation of the body part.

Finally, at step 518, the received data may be processed and the 3D object superimposed over the image or video stream. In step 518, an occlusion shader may be applied to the morphable model of the body part. The use of the occlusion shader can allow to not show portions of the 3D object that would not be visible due to being obscured by the body part when viewed from a particular point of view. Additionally and/or optionally, at step 520, if the system has been calibrated based on a standard reference object, the measurements of the body part and/or of the object may also be displayed over the image or video stream. For example, the measurements of may be provided both in universal measurement units (i.e., centimeters, inches, and so forth), or in size units particular to the object (i.e., regional shoe sizes, ring diameters and circumferences, and so forth).

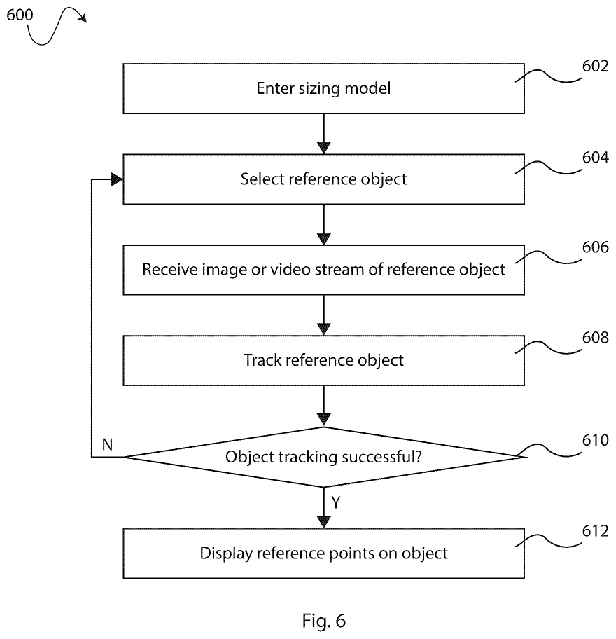

According to another exemplary embodiment, and as shown in FIG. 6, a method 500 for sizing and calibration of the system for visualization of three-dimensional objects is disclosed. At step 602, a user may select a sizing command in the system interface so as to enter the sizing mode. At step 604, the system may prompt a user to calibrate the camera of the device by selecting a standard reference object. Such a reference object may be any object with a standardized size, for example a credit card, driving license, passport, and so forth. At step 606, the system may receive an image or video stream of the reference object from a camera of the user's computing or communications device. At step 608, the system may track the standard reference object in the video stream. At step 610, the system may determine if tracking of the reference object was successful. If the tracking was unsuccessful, the system may display a message to the user that the scanning was unsuccessful and return to step 604. If the tracking was successful, the system, at step 612, may superimpose reference points over the image or video stream of the standard reference object, may display the dimensions of the reference object, and may display a message to the user that the scanning was successful and that the system is ready for sizing.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method for augmented reality visualization of virtual objects, comprising:
receiving a selected object of interest;
receiving and displaying a body part of a user in a video stream;
detecting a region of the video stream in which the body part of the user is located;
determining boundaries of the body part from visual data of the video stream utilizing neural networks or machine learning techniques;
recognizing anchor points on the body part utilizing visual data of the video stream and without utilizing 3D data;
segmenting the body part so as to determine boundaries of constituent parts of the body part utilizing the visual data of the video stream and without utilizing 3D data;
generating a three-dimensional model of the body part utilizing the visual data of the video stream;
superimposing, in real time in the video stream, a three-dimensional model of the object of interest in a desired location on the body part; and
continuously repositioning and reorienting, in real time in the video stream, the three-dimensional model of the object of interest in the desired location on the body part, based on a repositioning and reorienting of the body part.

2. The method of claim 1, further comprising displaying, in real time in the video stream, measurements of one or more of the body part and the object of interest.

3. The method of claim 1, wherein the body part is a hand, wrist, ankle or foot.

4. The method of claim 1, wherein the object of interest is jewelry.

5. The method of claim 1, wherein the object of interest is a ring, bracelet, watch, or anklet.

6. The method of claim 1, further comprising:
selecting a standard reference object;
tracking the standard reference object in the video stream; and
superimposing reference points of the standard reference object in the video stream.

7. A computer program product comprising a non-transitory computer-readable storage medium containing computer program code, the computer program code when executed by one or more processors causes the one or more processors to perform operations, the computer program code comprising instructions to:
receive a selected object of interest;
receive and displaying a body part of a user in a video stream;
detect a region of the video stream in which the body part of the user is located;
determine boundaries of the body part from visual data of the video stream utilizing neural networks or machine learning techniques;
recognize anchor points on the body part utilizing visual data of the video stream and without utilizing 3D data;
segment the body part so as to determine boundaries of constituent parts of the body part utilizing the visual data of the video stream and without utilizing 3D data;
generate a three-dimensional model of the body part utilizing the visual data of the video stream;
superimpose, in real time in the video stream, a three-dimensional model of the object of interest in a desired location on the body part; and
continuously reposition and reorient, in real time in the video stream, the three-dimensional model of the object of interest in the desired location on the body part, based on a repositioning and reorienting of the body part.

8. The computer program product of claim 7, wherein the computer program code further comprises instructions to display, in real time in the video stream, measurements of one or more of the body part and the object of interest.

9. The computer program product of claim 7, wherein the body part is a hand, wrist, ankle or foot.

10. The computer program product of claim 7, wherein the object of interest is jewelry.

11. The computer program product of claim 7, wherein the object of interest is a ring, bracelet, watch, or anklet.

12. The computer program product of claim 7, wherein the computer program code further comprises instructions to:
select a standard reference object;
track the standard reference object in the video stream; and
superimpose reference points of the standard reference object in the video stream.

13. (canceled)

14. The method of claim 1, wherein the recognizing step is performed by machine learning techniques.

15-16. (canceled)
